(19) United States
(12) Patent Application Publication
(10) Pub. No.: US 2004/0010094 A1
(43) Pub. Date: Jan. 15, 2004

(54) Injection moldable polyamide resin compositions containing poly carbo-di-imides and articles made therefrom

(76) Inventors: Kenichi Shinohara, Tochigi (JP); Masahiro Nozaki, Tochigi (JP)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/414,709

(22) Filed: Apr. 16, 2003

Related U.S. Application Data
(60) Provisional application No. 60/374,974, filed on Apr. 22, 2002.

(51) Int. Cl. C08G 69/48

(52) U.S. Cl. 525/419; 525/420

(57) ABSTRACT

Injection moldable polyamide resin compositions are disclosed incorporating poly carbo-di-imides in select ratios to nylon acid end groups. Articles formed from these compositions exhibit excellent physical attributes in fatigue and friction resistance and in melt flowability. These compositions may also incorporate a variety of additives and organic and inorganic fillers to tailor the material for specific applications.

### CROSS REFERENCE TO RELATED APPLICATIONS

This application claims the benefit of U.S. Provisional Application No. 60/374,974, filed Apr. 22, 2002.

### BACKGROUND OF THE INVENTION

1. Field of the Invention

This invention relates to polyamide resin compositions suitable for the injection molding of articles, which are characterized by greater toughness than has heretofore been possible with conventional polyamide molding compositions. More particularly, this invention relates to such compositions in which the polyamide resin is of a desirable molecular weight as well as viscosity by incorporating in the resin aromatic polycarbodiimide benzene and optionally including a variety of additives (including waxes, lubricants and fillers), so that articles made therefrom exhibit improved fatigue resistance.

2. Description of Related Art

Polyamide resin compositions are widely recognized as the materials of choice for any number of-molding applications. Significant attention has been directed towards the development of nylons that are stiff, tough, and heat stable. These properties are desirable from the standpoint of manufacturing articles that can exhibit characteristics required in today's demanding and rigorous end-use applications.

Japanese laid-open application 10-60269 is representative of nylon compositions intended for the manufacture of molded parts. There is disclosed therein high molecular weight polyamides having an intrinsic viscosity greater than 3.0 and in combination with polyolefins. However, its teachings are limited to compression molding applications.

Japanese laid-open application 62-185747 is directed to compositions of polyamide 4,6 (and having a relative viscosity or RV of greater than 1.5 and preferably 2.5-5.0) in combination with polytetrafluoroethylene powder (less than 15 microns in size), and optionally fillers (0-60 weight percent). However, this reference mentions only improved friction performance with 4,6 nylon and does not elaborate on the viscosity range nor the properties associated with this range.

Japanese laid open patent 9-89081 discloses an injection molding gear for use in general purpose engines, which is formed by injection molding a polyamide resin such as polyamide 6/6 followed by heat treatment. The relative viscosity measured in a 1.0% concentration solution of 98% sulfuric acid is not less than 3.5. However, it does not recognize or suggest the problem of adverse-effects on mechanical properties other than strength. In particular the loss of dimensional accuracy due to the necessity of applying heat treatment after molding, resulting in the inevitable loss of balance of mechanical properties of polyamide molded gears, is not addressed.

Japanese laid open patent 6-16933 discloses polyamide compositions containing 0.1-5 weight percent aromatic carbodiimide and resulting in the improvement of hydrolysis resistance thereof.

Japanese laid open patent 11-343408 discloses polyamide compositions comprising 0.01-20 weight percent aliphatic carbodiimide based on 100 weight percent of polyamide, which has improved hydrolysis, oil and metal halide resistance. These materials are of interest in automotive steering assist gears, which are subject to loading environments that often cause gear teeth to chip or fracture. Specifically, the RV ranges disclosed in these polyamides (for example 70-350 in 90% formic acid) impart injection-moldability to the compositions, thereby significantly improving fracture toughness as compared to standard grades of polyamides. However, such highly viscous polyamides sometimes show poor flow properties making them unsuitable for the manufacture of injection molded gears with small and/or complex designs.

It is an object of the present invention to provide polyamide resin compositions which are injection moldable, and further which are used to produce articles having improved toughness without impairing other properties of the polyamide. It is a further object of the invention to provide injection moldable articles that exhibit remarkable processability without increasing the melt viscosity. One feature of the invention is its suitability for the manufacture of gears (such as automotive steering assist gears, window lifting gears and wiper motor gears) which are capable of withstanding high loads placed on the gear teeth. This promotes an improvement in the life of such gears. Further, the present invention provides excellent flow properties to facilitate the molding of injection mold gears having small and/or complex designs. An advantage of the instant polyamide resins disclosed herein is that they may include a number of additives such as reinforcing or filling materials, lubricants, pigments, flame retardants, mold-release agents, ultraviolet light and heat stabilizers, nucleating agents and the like. These and other objects, features and advantages of the present invention will become more readily apparent upon having reference to the following description of the invention.

### SUMMARY OF THE INVENTION

There is disclosed and claimed herein injection moldable polyamide resin compositions comprising one or more polyamides having acid end groups thereon, and aromatic or aliphatic poly carbo-di-imides, in a ratio of 0.10-3.50 molar equivalents of carbo-di-imide groups in said poly carbo-di-imides to said acid end groups.

Suitable polyamides may be either aliphatic or aromatic, or a combination thereof. In a preferred embodiment, the polyamides are selected from any of polyamide 66, 6, 46, 610, 612, aromatic polyamides comprising at least 20 mol percent of one or more aromatic monomers, and blends of any of these. Suitable aromatic monomers include terephthalic acid, isophthalic acid, and mixtures thereof.

### DETAILED DESCRIPTION OF THE INVENTION

The polyamides useful in the present invention may be manufactured from a broad range of materials. Useful nylon homopolymers may be produced using adipic acid, azelaic acid, sebacic acid, dodecanedicarboxylic acid, isophthalic acid or terephthalic acid, and in conjunction with tetramethylene diamine, hexamethylenediamine, 2-methyl-pentamethylenediamine, octamethylendiamine, nonamethylendiamine, 2-methyl-octamethylenediamine, trimethylhexamethylenediamine, bis-(4-aminocyclohexyl)-methane or 2,2-bis(4′-aminocyclohexyl)-propane. These designations are readily understood by those skilled in the art. For example, representative nylons may be selected from polycaprolactam (nylon 6) polyhexamethlyene dodeconedicarboxylic acid (nylon 6,12), polyhexemethylene adipamide (nylon 6,6) or polytetramethylene adipamide (nylon 4,6), poly 2-methyl-penatamethylene telephthalamide, poly polyhexamethlyene terephthalamide (nylon 6T), poly hexamethlyene isophthalamide (nylon 61), nylon 6T61 and partially aromatic polyamide, for example, nylon 6T66, nylon 6T6166, nylon 6166. At least 20 mol % of one or more aromatic monomers may be included therein.

These materials may be manufactured using a variety of techniques also readily known and appreciated among those skilled in the art, for example polymerization in an autoclave, one step or continuous polymerization by applying suitable pressure and temperature taught in U.S. Pat. No. 5,378,800 (incorporated by reference herein), or polymerization on an extruder from oligomers by applying suitable temperature and vacuum. An alternative process includes preparing a prepolymer and subjecting it to solid-phase polymerization or melt-mixing in an extruder to increase the degree of polymerization. Further, an increase in viscosity may be obtained by solid phase polymerization such as described in the aforementioned patent.

The polycarbo-di-imide is selected from aliphatic polycarbo-di-imides and aromatic polycarbo-di-imides. These are represented by the following chemical formula, in which—R—represents aliphatic or aromatic radicals. The polycarbidiimides can be synthesized using aliphatic or aromatic carbide fragments, selected by either one of the listed radicals or a mixture of one or more radicals.

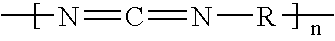

R: aliphatic or aromatic radical (including without limitation 2,6-diisopropylphenyl, naphtalene, 3,5-diethyltoluene, 4,4′-methylene-bis-(2,6-diethylephenyl), 4,4′-methylene-bis(2-ethyl-6-methylphenyl), 4,4′-methylene-bis(2,6-diisopropylphenyl), 4,4′-methylene-bis(2-ethyl-6-methylcyclohexyl), 2,4,6-tir-isopropylphenyl, hexamethylene, cyclohexane, dicyclohexylmethane, and methylcyclohexane). (Reference: JP-2000-26703, HP-1994-16933)

The aforementioned polyamide resin compositions are preferable for a number of applications requiring high durability, such as gears in which the gear teeth are under repetitive and exceptional loads. One such area of interest is automotive steering assist gears, which are subject to loading environments that often cause gear teeth to chip or fracture. Further, this invention provides injection moldable articles that exhibit remarkable processability without an increase of melt viscosity, thereby facilitating the manufacture of injection mold gears with small and/or complex designs.

The molar equivalent ratios of the polycarbo-di-imides to the polyamide acid end groups as disclosed and claimed herein are determined based on molecular interaction between the polyamide resin and the polycarbo-di-imide. More specifically, one important element in developing improved nylon using polycarbodiimides is the molecular interaction of the carbodiimide with the nylon polymer through the carbodiimide (—N═C═N—) group and the nylon polymer end carboxy (—COOH) group. Without intending to advance any particular theory, one possible explanation of this observation is that toughness is acentuated by the one-to-one interaction of these functional groups. Another possible explanation is that both functional groups react with each other chemically as seen below.

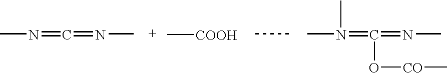

There are two factors to promote gear life—fatigue resistance and a low friction environment. The polyamide resin compositions herein are well suited for parts which must exhibit these properties. The high molecular weight of the polymer is found to provide high fracture toughness, which in turn promotes high fatigue resistance. This property is very important for longer gear life because the gear teeth must resist repeated impact from other gears and gear teeth during power transmission. Broken gears are often associated with fatigue.

A low friction envoironment—the second factor—provides less heating of the gear teeth caused by friction between gears. Polymers when heated exhibit a lower strength and modulus (eg they are easy to deform). Any of a number of additives may be incorporated with the polyamides disclosed herein to enhance low friction properties between the gears in such an amount that they do not harm the characteristic properties of the composition of the present invention. These include without limitation polytetrafluoroethylene (PTFE) and silicone, and preferably silicone. Further, waxy lubricants such as aliphatic and/or aromatic ester, ether and amides may be used.

In addition, various inorganic or organic fillers have been identified as improving creep resistance and may be incorporated into the polyamide resin compositions herein. Suitable fillers include inorganic materials such as wollastnite, kaolin, talc, mica, alumina, silica, magnesium oxide, calcium silicate, magnesium silicate, metal whisker, potassium titanate whisker and the like. Moreover, organic fillers such as carbon fiber, aramid fiber (for example KEVLAR® aramid fiber from E I DuPont de Nemours and Company), and the like may also be used. The amount of the fillers added can be in the range of 5-70 weight percent based on the polyamide resin and the filler. These fillers may be added during compounding or injection molding processes associated with the polyamide.

The polyamide resin composition of this invention can be prepared by melt-mixing the aforementioned polyamide and carbo-di-imide, and, further, as desired, necessary additives and/or other resins. There are no particular limitations on the method of preparation. For example, the compositions can be prepared by a method such as compounding the polyamide and carbo-di-imide, and, further, as desired, necessary additives on a twin screw extruder. Further, solid phase polymerization is an effective way to increase toughness.

The invention will be better understood upon having reference to the following examples of the invention.

### EXAMPLES

Test Method

The testing of energy for breakage was conducted using molded specimens having the following dimensions: 12 mm high×125 mm in length×3.2 mm in thickness. The mold specimen has a notch that is identical in both shape and size to that set forth in the ASTM D256 test at the center of the test specimen. The testing proceeded so that the specimen was bent from the opposite side of the notch. The test speed of bending was 10 mm/minute and the span for the bending test was 50 mm. Energy for breakage was calculated in the following manner: first calculate the area of stress-strain curvature until break and then divide this value by the initial volume in-between the span.

Other pertinent testing informaton is as follows. Higher fracture toughness was indicated by higher energy for breakage. Nylon 6,6 was molded at a mold temperature of 65 C and a melt temperature of 300 C. RV is expressed in relation to 90% formic acid. Melt viscosity was measured on Keyness viscometer equipped with an orifice having 0.762 mm diameter and 15.24 mm length, and run at 280 C and 990 sec⁻¹

Test Compositions and their Properties

The details and findings of the experimental work can be found in the following Table I:

The components shown in Table I were as follows:

Polyamide A: Nylon 66 which RV is 49.5

Polyamide B: Nylon 66 which RV is 180 prepared by solid phase 49.5 RV nylon 66

Carbo-di-imide: Stabaxol P made by Bayer

Note: The amount of Polyamide A or B and inorganic heat stabilizer is provided in weight percent.

TABLE I

| | Examples | | | | | Comparative Examples | | |
|---|---|---|---|---|---|---|---|---|
| | 1 | 2 | 3 | 4 | 5 | 1 | 2 | 3 |
| Polyamide A | 99.75 | 98.75 | 98.25 | 97.75 | 92.75 | 99.65 | | 99.55 |
| Polyamide B | | | | | | | 99.77 | |
| Molar equivalent ratio carbo-di-imide/ | 0.20 | 0.41 | 0.85 | 1.14 | 2.84 | | | 0.10 |
| nylon acid end | | | | | | | | |
| Inorganic Heat stabilizer | 0.25 | 0.25 | 0.25 | 0.25 | 0.25 | 0.45 | 0.23 | 0.25 |
| Before solid phase polymerization (SPP) | | | | | | | | |
| RV | 51 | 70 | 83 | 78 | 63 | 42 | | 47 |
| MV | 244 | 259 | 300 | 290 | 290 | 170 | | 173 |
| Energy for breakage kg·cm/cm3 | 5.4 | 6.4 | 10.6 | 6.0 | 5.2 | 1.7 | | 2.8 |
| After SPP | | | | | | | | |
| RV | 77 | 96 | 119 | 111 | 130 | 53 | 180 | 60 |
| MV | | 410 | | | | | 360 | |
| Energy for breakage kg·cm/cm3 | 11.5 | 12.0 | 13.2 | 12.0 | 10.5 | | 5.5 | |

### Example 1

Polyamide A containing 0.20 of molar equivalent ratio of carbo-di-imide to nylon acid end and 0.25% Cu heat stabilizer.

### Example 2

Polyamide A containing 0.41 of molar equivalent ratio of carbo-di-imide to nylon acid end and 0.25% Cu heat stabilizer.

### Example 3

Polyamide A containing 0.85 of molar equivalent ratio of carbo-di-imide to nylon acid end and 0.25% Cu heat stabilizer.

### Example 4

Polyamide A containing 1.14 of molar equivalent ratio of carbo-di-imide to nylon acid end and 0.25% Cu heat stabilizer.

### Example 5

Polyamide A containing 2.84 of molar equivalent ratio of carbo-di-imide to nylon acid end and 0.25% Cu heat stabilizer.

### Comparative Example 1

Polyamide A containing no carbo-di-imide and 0.45% Cu heat stabilizer.

### Comparative Example 2

Polyamide B containing no carbo-di-imide and 0.23% Cu heat stabilizer.

### Comparative Example 3

Polyamide A containing 0.10 of molar equivalent ratio of carbo-di-imide to nylon acid end and 0.25% Cu heat stabilizer.

Overall these data illustrate that the addition of 0.20-2.84 of molar equivalent ratio of carbo-di-imide to nylon acid provided higher energy for breakage, which is comparable to high molecular weight polyamide. Moreover, it is expected that these same beneficial results are attainable at molar equivalent ratios as low as 0.01 and as high as 3.50. Across this range the effects in improved toughness versus compositions without poly carbo-di-imides are evident.

The melt viscosity of the instant material is shown to be lower than that of the high molecular weight polyamide, which provides a desirable improvement in flow characteristics. Further, it is enable to eliminate additional polymer processing, solid phase polymerization to reach the comparable energy for breakage.

1. An injection moldable polyamide resin composition comprising one or more polyamides having acid end groups thereon, and aromatic or aliphatic poly carbo-di-imides, in a ratio of 0.10-3.50 molar equivalents of carbo-di-imide groups in said poly carbo-di-imides to said acid end groups.

2. The composition of claim 1 wherein said polyamides are aliphatic polyamides.

3. The composition of claim 1 wherein said polyamides are selected from the group consisting of polyamide 66, 6, 46, 610 and 612, and blends thereof.

4. The composition of claim 1 wherein any of said polyamides further comprise at least 20 mol percent of one or more aromatic monomers.

5. The composition of claim 4 wherein said aromatic monomers are selected from the group consisting of terephthalic acid, isophthalic acid and mixtures thereof.

6. The composition of claim 1 wherein said polyamides comprise a mixture of one or more aliphatic polyamides and one or more aromatic polyamides and wherein said aromatic polyamides further comprise at least 20 mol percent of aromatic monomer.

7. A gear manufactured from any of the compositions of claims 1 to 8.

8. The composition of claim 1 wherein said ratio of molar equivalents of carbo-di-imide groups in said poly carbo-di-imides to said acid end groups is 0.2-2.84.
